(19) United States
(12) Patent Application Publication
(10) Pub. No.: US 2021/0097819 A1
(43) Pub. Date: Apr. 1, 2021

(54) Wagering Services Systems and Methods

(71) Applicant: Adam Bilzerian, Crosslake, MN (US)

(72) Inventor: Adam Bilzerian, Crosslake, MN (US)

(21) Appl. No.: 16/649,017

(22) PCT Filed: Dec. 11, 2019
(86) PCT No.: PCT/US19/65720

§ 371 Date: Mar. 19, 2020

Related U.S. Application Data
(60) Provisional application No. 62/908,792, filed on Oct. 1, 2019.

(51) Int. Cl. G07F 17/32; G06Q 50/34

(52) U.S. Cl. CPC G07F 17/3288; G06Q 50/34; G07F 17/3223

(57) ABSTRACT

A system and method for providing wagering services that includes analysis and valuation of wagers after they are placed and communication of the value of the wager to the user. The wagering services offered by the operator can include leveraged wagers, including leveraged wagers on a single bet in a single game. The system and method allow for liquidation of certain wagers when the value of the wager decreases, which allows for the mitigation of risk to the wagering services operator.

This application claims priority to U.S. Provisional Appl. No. 62/908,792 filed Oct. 1, 2019, which is incorporated in its entirety by reference.

### BACKGROUND

Sports wagering services offered at casinos and on the Internet have limited themselves to traditional wagering services where the user's winnings are solely determined by the amount deposited with the operator of the services. The operators of these typical sports wagering services also offer futures bets at less than ideal odds.

Embodiments of the present invention can solve those problems through novel and efficient means for providing leveraged wagering options to users, as well as providing genuine sports futures wagers. Specifically, the disclosed unique systems and methods allows users to extend on wagers beyond their deposit while at the same time: mitigating the risk to the operator of the services.

### SUMMARY

The invention is generally directed to a method and system for providing wagering services to users. The method and system can include a data processing system, including server(s), adapted to: receive a selection of an event from a user over a network, analyze the event using a plurality of factors, transmit wagering options related to the event to the user over a network, receive the selection of the wagering option from the user over a network, continuously analyze the selected wager from the user using a plurality of factors until the event associated with the wager ends or the wager is otherwise ended, and transmit the value of the wager to the user over network based on the continuous analysis, including upon an increase or decrease in the value of the wager, and/or a particular threshold. The selected event can include an event that is not a sporting event. More particularly, the invention is directed to a method and system of providing certain wagering options to users including leveraged wagering options, wherein the leveraged wagering options can allow users to wager more than the amount deposited in their account, and subject to certain conditions, allow the user to win the leveraged amount without further deposit of funds. The leveraged wagering options provided by the server can include a single bet for a single sporting event and can also include futures wagers and be related to events that are not sporting events. The method and system can also provide for a liquidation of certain leveraged wagers by the provider of the wagering services depending on certain conditions, including the failure of the server to receive an additional deposit from the user. The system and method can include a data processing system, including server(s), adapted to: send a request for an additional deposit from the user when the value of the wager decreases and liquidate the leveraged wager based on the analysis of the data processing system and the failure of the data processing system to receive an additional deposit from the user. The system and method have the advantage of allowing the user to select from increased wagering, while at the same time allowing the provider of the wagering services some amount of potential mitigation of loss. One part of the efficiency of the invention relates to its use of historical and real time information to provide the most accurate analysis of a sporting event and of specific wagers related to that event.

The invention is further directed to a system and method of providing wagering services wherein wagers, including wagers on future events and leveraged wagers, are continuously valued based on certain conditions and can be bought and sold by users, including the provider of the wagering services. The system and method can include a data processing system, including server(s), that are adapted to receive a selection from a user to sell a selected wager.

Although the examples illustrated and described herein are embodied in a novel system and method, the invention is, nevertheless, not intended to be limited to the details shown because various modifications and structural changes may be made therein without departing from the spirit of the invention. Additionally, well-known elements of exemplary embodiments of the invention will not be described in detail or will be omitted so as not to obscure the relevant details of the invention.

Other features that are considered as characteristic for the invention are set forth in the claims. Detailed embodiments of the present invention are disclosed herein; however, it is to be understood that the disclosed embodiments are merely exemplary of the invention, which can be embodied in various forms. Specific structural and functional details disclosed herein are not to be interpreted as limiting, but merely as a basis for the claims and as a representative basis for teaching one of ordinary skill in the art to variously employ the present invention in an appropriately detailed structure. Further, the terms and phrases used herein are not intended to be limiting; but rather, to provide an understandable description of the invention. While the specification concludes with claims defining the features of the invention, it is believed that the invention will be better understood from a consideration of the following description in conjunction with the figures. The figures are not drawn to scale.

### BRIEF DESCRIPTION OF THE DRAWINGS

FIG. 1 is a block diagram of an embodiment of a wagering services system.

FIG. 2 is an embodiment of a data processing system used to implement wagering services.

FIG. 3 is a block diagram of an embodiment of a wagering services system.

FIG. 4 is an embodiment of a graphical user interface for use in a wagering services system.

FIG. 5 is a an embodiment of a data table used by an embodiment of wagering services system for determining the types of leveraged bets offered to users.

FIG. 6 is a flowchart showing a series of events and actions by an embodiment of a wagering services system.

FIG. 7 is a flowchart showing a series of events and actions by an embodiment of a wagering services system.

FIG. 8 is a flowchart showing a series of events and actions by an embodiment of a wagering services system.

### DESCRIPTION OF THE EMBODIMENTS

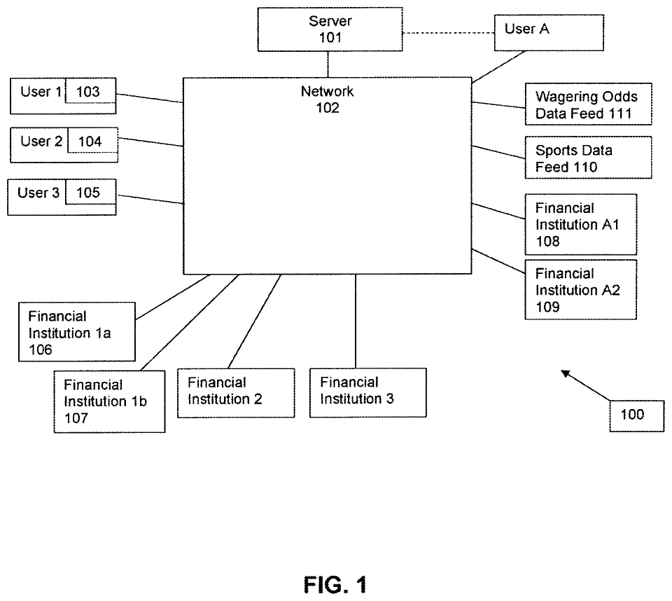

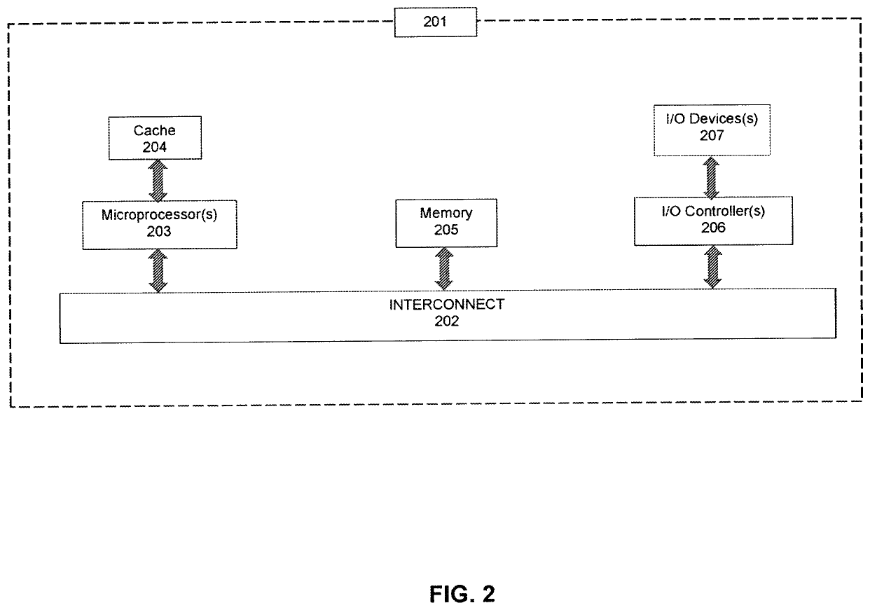

FIG. 1 represents a system 100 configured to provide sports wagering services according to an embodiment of the invention. In one embodiment, the services are implemented at least in part in at least one server 101, which, in certain embodiments can be accomplished using one or more data processing systems as illustrated in FIG. 2. A plurality of user devices (e.g., 103, 104, 105) are coupled to the server 101 via a network 102, which can include a local area network, a wireless communication network, a wide area network, and/or the Internet. A user device can be one of various points connected to a network such as a personal computer, a tablet, a cellular phone, a smart phone, and/or a mobile phone. In an embodiment, the server 101 is operated by sports wagering provider User A, who can access the server 101 through a network 102 and/or other means.

In an embodiment, User 1 installs and operates application on user device 103 which is a smart phone. In an embodiment, after downloading and installing the application, User 1 can interact with a graphical interface in the application. User 1 can input personal information, which can include name, address, mails, phone numbers, in the graphical interface of the application which can transmit the information to the server 101. After receipt of the personal information, the server 101 can save the information and establish an account for User 1. After establishing the account, the server 101 can transmit a message to User 1 indicating an account has been established. The message can be transmitted by multiple means including via email, text message, and/or message in the application.

User 1 can also input financial information, including banking information, credit card information, amounts to be deposited, into the graphical user interface in the application installed on user device 103, which can then be transmitted to the server 101. In one particular embodiment, User 1 can input more than one source of finds for deposit (or withdrawal) into the graphical interface for transmission to the server 101. For example, User 1 could transmit financial information about Financial Institution 1a 106 and 1b 107 and select these institutions as sources of funds for deposit or withdrawal based on User 1 selections in the application.

After receipt of the financial information from the User 1, the server 101 saves the information and associates it with User 1's account. Further, after receipt of financial information, the server 101 can transmit a request to Financial institution 1a 106 and/or 1b 107 to verify the information provided by User 1. Further, if a deposit amount is selected by User 1 in the application and transmitted to the server 101, the server 101 can request the deposit amount from Financial Institution 1a 106 and/or 1b 107 be deposited in an account designated by the operator of the server. For example, as shown in FIG. 1, User A is the operator of the server 101, and has designated Financial Institution A1 108 for the deposit of all funds designated by User 1. In one embodiment, the operator of the server can designate how all funds deposited by users of the sports wagering services can be transferred or deposited. For example, as shown in FIG. 1, User A may designate funds from users of the wagering services (Users 1, 2 and 3) be deposited in a plurality of Financial Institutions (108 and 109).

In certain embodiments of the invention, users can access the sports wagering services provided by the server through multiple means, for example, via downloaded application on a smart phone, tablet, or personal computer, downloaded software on a smart phone, tablet, or personal computer, via web browser on a smart phone, tablet, or personal computer, via mobile phone messaging, and the other similar means.

In certain embodiments, after an account is established by the server 101 for a user of the wagering services, the user may select from a plurality of sporting events to wager on, including wagering on events that involve a point spread bet, a money line bet, an odds bet, and/or an over/under bet. The events that can be wagered on by the users of the wagering system can occur in the future or can be in an in-game situation. Further, in some embodiments of the invention, the event wagered on need not involve sports.

As shown in FIG. 1, the server 101 can also be connected to at least one sports data feed 110 and at least one wagering odds data feed 111. The at least one sports data feed 110 can include scores and status of sporting events in real time or near real time. The server 101 can store certain sports data from the sports data feed 110 (including individual box score data and team/individual standings). The sports data from the sports data feed 110 that is stored by the server 101 can be stored in addition to the storage of historical sports data. The server 101 also store any additional sports data (via feed or historical) as directed by the operator of server at any time. For example, if additional data from sporting events, or data related to sporting events (i.e., analytics, injury reports, trades, coaching changes, weather, location, sports player news, and the like), becomes available, the operator can direct the server 101 to store such additional data and/or connect the server 101 to a real time feed(s) for such data—which can also be stored.

The at least one wagering odds data feed 111 can include wagering odds data from casinos, online sportsbooks, brick and mortar sportsbooks, and the like. Essentially, any wagering odds data that is publically available or available for purchase can be received and stored by the server 101. The wagering odds data can include pre-game odds, in-game odds, futures wagers, % money on either side of the wager. The wagering odds data can be received in real or near real time such that the server 101 can update the data and store trends and changes, and as described further, analyze such trends and changes. The server 101 can store wagering odds data from the wagering odds data feed 111. The wagering odds data from the feed 111 that is stored by the server 101 is stored in addition to historical wagering odds data. The server 101 can also store any additional wagering data as directed by the operator of server at any time.

In one embodiment, at least some of the components of the system disclosed herein can be implemented as a computer system, such as a data processing system illustrated in FIG. 2, with more or fewer components. Some of the components may share hardware or be combined on a computer system. In one embodiment, a network of computers can be used to implement one or more of the components. In some embodiments, a data processing system may comprise a single server. In some embodiments, a data processing system may comprise multiple servers and/or further components.

In one embodiment, data discussed in the present disclosure can be stored in storage devices of one or more computers accessible to the components discussed herein. The storage devices can be implemented as a data processing system illustrated in FIG. 2 with more or fewer components.

FIG. 2 illustrates a data processing system according to one embodiment. While FIG. 2 illustrates various parts of a computer system, it is not intended to represent any particular architecture or manner of interconnecting the parts. One embodiment may use other systems that have fewer or more components than those shown in FIG. 2.

In FIG. 2, the data processing system 201 includes an interconnect 202 (e.g., bus and system core logic), which interconnects a microprocessor(s) 203 and memory 205. The microprocessor 203 is coupled to cache memory 204 in the embodiment of FIG. 2.

In one embodiment, the interconnect 202 connects the microprocessor(s) 203 and the memory 205 together and also connects them to input/output (I/O) device(s) 207 via I/O controllers) 206. I/O devices 207 may include a display device and/or peripheral devices. In one embodiment, when the data processing system 201 is a server system, I/O devices 207 can be optional.

In one embodiment, the interconnect 202 includes one or more buses connected to one another through various bridges, controllers and/or adapters.

In one embodiment, the memory 205 includes one or more of ROM (Read Only Memory), volatile RAM (Random Access Memory), and non-volatile memory, such as hard drive, flash memory, etc.

The non-volatile memory can be a local device coupled directly to the rest of the components in the data processing system. A non-volatile memory that is remote from the system, such as a network storage device coupled to the data processing system through a network interface.

In this description, some functions and operations are described as being performed by or caused by software code to simplify description. However, such expressions are also used to specify that the functions result from execution of the code/instructions by a processor, such as a microprocessor.

While one embodiment can be implemented in fully functioning computers, computer systems, mobile devices, and the like, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement embodiments of the inventor may be implemented as part of an operating system or a specific application, component, program, object, module or sequence of instructions that can include one or more instructions set at various times in various memory and storage devices in a computer, smartphone or the like, and that, when read and executed by one or more processors, cause the performance of operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or networks. Different portions of the data and instructions can be obtained from different centralized servers and/or networks and at different times, data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

In general, a machine readable medium includes any mechanism that provides(i.e., stores and/or transmits) information in a form accessible by a machine (e.g., a computer, mobile devices, network device, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

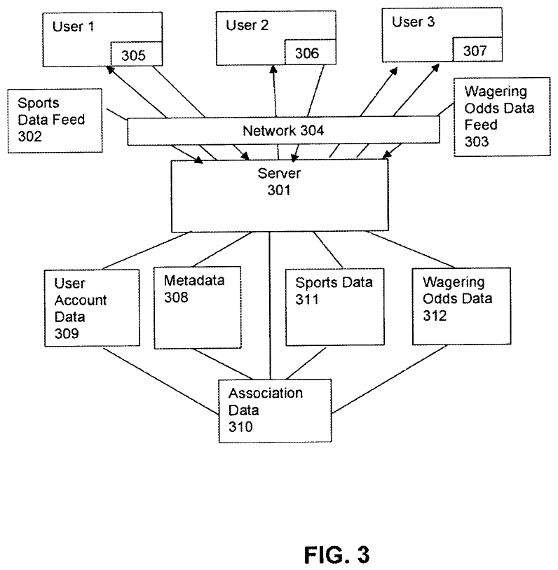

As shown in FIG. 3, in certain embodiments of the invention, the server 301 can associate data from the sports data feed 302 (and historical data) to the wagering odds data feed 303 and historical wagering data. Further, the server 301 can store and update such associations of data. The server 301 can also access and use such associations 310 in transmitting sports wagering options and services to users.

In certain embodiments, the server 301 can receive (via a network 304) and store metadata (such as 305, 306, 307) associated with wagering options viewed and/or selected by a user. Such metadata can include types of sporting events and/or wager types the user has searched for, the length of time the user viewed certain sporting events and/or wager types, and/or the wagers made by the user and the outcome of such wagers. The server 301 can associate such stored metadata 308 with the user account data 309 and/or with metadata 308 from other users. The server 301 can analyze metadata (305, 306, 307, 308) from multiple users and store trends and other associations 310 from such analysis. This analysis can occur in real time or near real time. In embodiments of the invention, the server 301 can analyze, make, and store associations 310 from the sports data feed 302, stored sports data 311, wagering odds data feed 303, stored wagering odds data 312, metadata (305, 306,307, 308), and/or user account data 309. In a preferred embodiment of the invention, data from the sports data feed 302, stored sports data 311, wagering odds data feed 303, stored wagering odds data 312, metadata (305, 306, 307, 308), user account data 309 and/or association data 310 are factors in determining a leveraged sports wager that can be transmitted to a user through a network 304 by a server 301, and that can be selected by the user on a graphical interface via various alternative means (e.g., through web browser access on a personal computer, smart phone, or tablet, through an application downloaded on a smart phone, personal computer, or tablet, and/or through software downloaded on a smart phone, personal computer, or tablet). In certain embodiments, the leveraged sports wager can be single bet on a single game a paint spread bet). The leveraged sports wager may also be sent by the server 301 to a user via text message or email message. Such message sent to the user may contain a link for accessing the wager via web browser, application, or downloaded software.

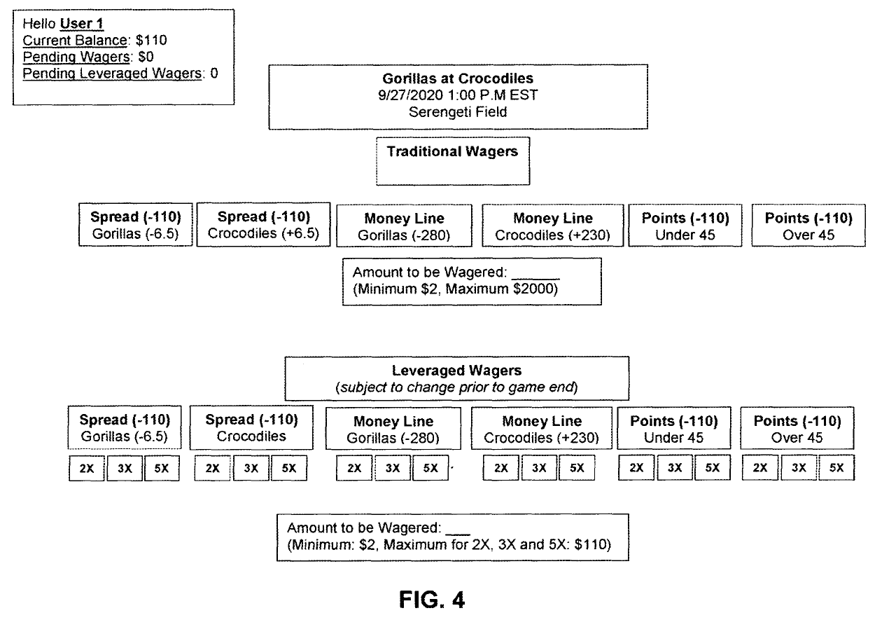

FIG. 4 shows an example of a graphical interface for an application that can connect to a wagering services server (e.g., 101 in FIG. 1). The graphical interface in FIG. 4 shows two distinct types of a wagering for a football game that can be provided by various embodiments. The first set of options are traditional wagers for a football gar (here, the Gorillas at the Crocodiles) including a point spread (here Gorillas −6.5 or Crocodiles +6.5), over under point total (under 45 or over 45), and money line (Gorillas −280 or Crocodiles +230). In various embodiments, these wagers would be provided by the operator of the wagering services server at typical odds (e.g., User A in FIG. 1). In various embodiments, including the example in FIG. 4, a point spread bet would be offered at −110 (i.e., a $110 bet by a user pays $100 if the wager is correctly picked). In certain embodiments, the amount wagered on the offered wagers would be determined by a user, with a maximum bet set by the operator of the wagering services server (as shown in FIG. 4, the maximum is $2000) or the total amount deposited in the user's account or otherwise determined to be available to the user and available for immediate deposit in the user's account example, the user has a credit card on file and authorizes amounts in excess of the currently deposited amount by the user to be deposited at the time of the bet).

As also shown in FIG. 4, in certain embodiments, the wagering services server can also transmit options for leveraged wagers to a user (here, User 1). For example, in FIG. 4, each of the traditional football bets are offered at 2× leverage, 3× leverage, and 5× leverage to User 1. As shown in this example, leveraged wagers offered by the server do not need to be combined with other wagers offered by the server in order to be placed (i.e., the user can bet with leverage on a single bet for a single sporting event). In some embodiments, the amount of leverage offered by the wagering services server to a user is determined by certain factors, including the amount deposited in the user's account, amounts previously deposited in the user's account, the wagering history of the user, pending wagers from the user received by the system, the odds of the wager, sports information data (real time and stored), and/or wagering odds data (real time and stored). In the embodiment shown in FIG. 4. the leveraged bets are offered up to a particular amount ($110) for this particular user (User 1). As shown in FIG. 4, User 1 has $110 in their user account at the time the offered leveraged bets were transmitted to User 1's device. In a particular embodiment, when User 1 uses a smart phone application to select the leveraged wager of 2× for the spread bet of the Gorillas (−6.5) with an amount wagered of $110, the application transmits the selection to a server that is operated by the operator of the sports wagering services. After receiving the 2× wager for $110, the server sends a message to User 1 indicating the potential payout of the bet if the Gorillas win by more than 6.5 points and also indicating the bet is subject to potential increases in value, decreases in value, and potential liquidation prior to the end of the game. In this particular example (2× $110 bet), the server would send a message indicating a potential payout of $200 along with notices that the bet is subject to change prior to game.

One important aspect of the invention is the ability of embodiments to effectively allow a user to bet more than the amount of funds currently in the user's account as indicated by User 1's 2× wager using $110 dollars in FIG. 4. The methodology implemented by wagering services server before and after a leveraged wager is transmitted to the server and prior to the end of the game is what allows for an efficient leveraged betting system for the operator of the wagering services server. Further, the ability of the system to offer leveraged bets provides a benefit to the user wagering on games in the form of higher payouts based on lower deposit amounts wagered.

In certain embodiments, a low amount deposited in a user's account would be a positive factor in the system's determination of the amount of leverage offered to that particular user. In certain embodiments, a high amount deposited in the user's account (e.g., >$5000) would be a negative factor in the system's determination of the amount of leverage offered to that particular user. In certain embodiments, a greater than 60% success rate in wagers made on the system would be a negative factor in the system's determination of the amount of leverage offered to that particular user. In certain embodiments, a less than 45% success rate in wagers made on the system would be a positive factor in the system's determination of the amount of leverage offered to that particular user.

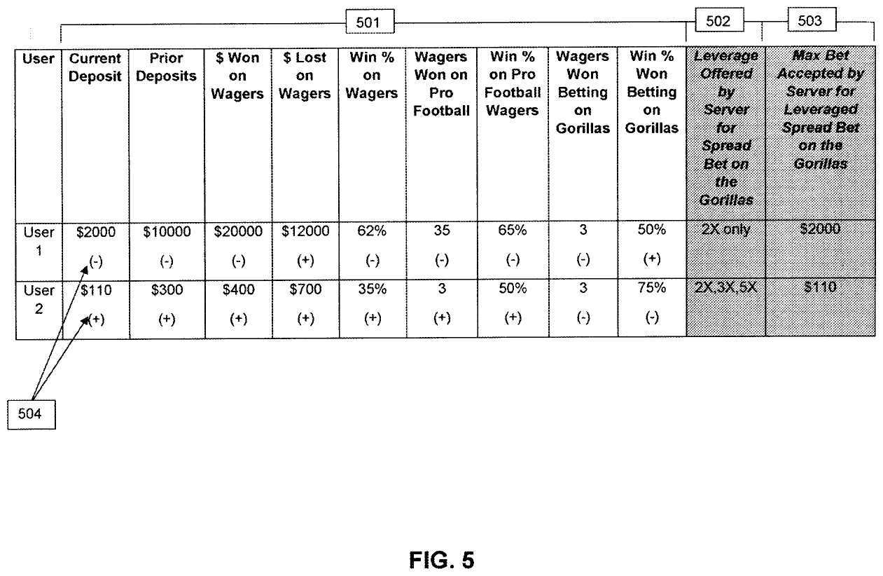

FIG. 5 shows a particular example of a plurality of factors 501 that can be used by various embodiments of the wagering services server to analyze the amount of leverage offered 502 to a particular user, here User 1 and User 2, and the maximum bet allowed 503 for the particular user for the offered leverage. In certain embodiments of the invention, the factors in FIG. 5 can have different positive or negative correlations 504 that are used by the wagering services server in determining the amounts of leverage offered 502 to particular users for particular wagers and the maximum bet allowed 503 for the leverage offered 502.

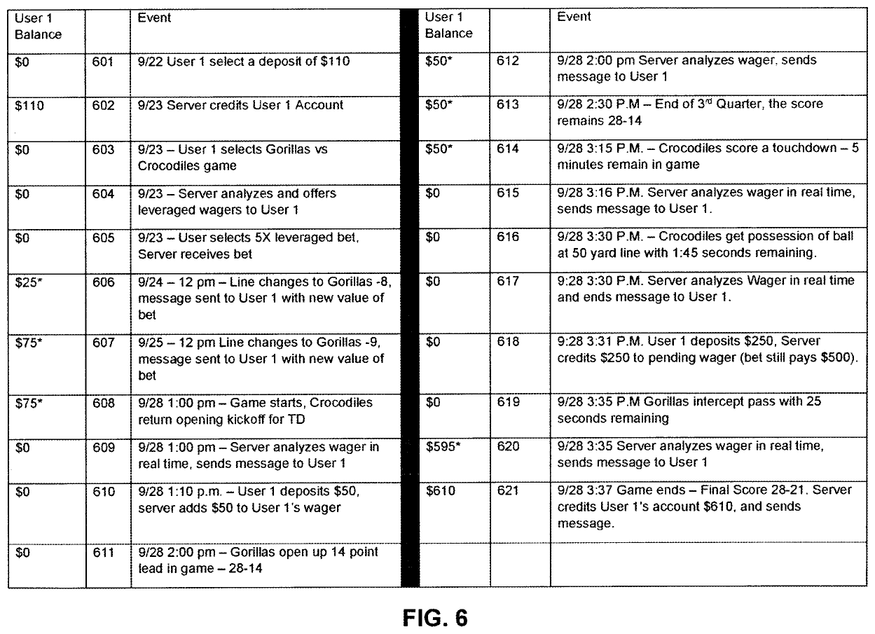

FIG. 6 is a diagram showing an example of the operation of an embodiment of the invention following the selection of a leveraged bet with the sports wagering system. Particularly, FIG. 6 details an example of events and actions that can be performed by the wagering services server following the placement of the 5× $110 wager on the Gorillas (−6.5) versus Crocodiles football game previously discussed in FIG. 4. The first column of FIG. 6 shows User account balance (saved and updated in the wagering services server) as events and actions take place.

At 601, User 1 selects a deposit of $110 from a smartphone application. The application transmits the selection of the deposit to a server (e.g., the wagering services server in FIG. 1). At 602, the server receives User 1's selection of the deposit, verifies the financial information, and credits User 1's account with $110. At 603, User 1 selects the Gorillas vs, Crocodiles game on a smartphone application, the selection is transmitted by the application and received by a server. At 604, the server analyzes a plurality of factors, including historical and current sports data, historical and current wagering odds data, and metadata related to User 1 and other users of the sports wagering services provided by the operator of the server. Following the analysis, the server transmits to User 1's smartphone the wagers available for the Gorillas versus Crocodiles game, including leveraged wagers. One of the wagers received and displayed by the application on User 1's phone is a 5× leveraged wager for a −6.5 spread bet (−110 odds) on the Gorillas. At 605, User 1 selects the 5× leverage bet for $110 and the application transmits the selection to the server. Upon receipt of the transmitted selection, the server deducts User 1's account by $110 while the leveraged wager is pending. From this point until completion of the Gorillas game, the server continuously analyzes the leveraged wager using a plurality of factors discussed herein. As User 1's account is updated by the analysis of the server, including with the current balance of User 1's account, the server can provide the updated information to any device that User 1 is using to access the wagering services system, (i.e., smartphone application, personal computer software, web browser).

At 606, the wagering line for the Gorillas game specifically, the line used and offered to users by the server for that game changes to the Gorillas (−8). Upon line change, the server sends a message to User 1 via the application on User 1's smartphone and also sends the same message to User 1's email—which is stored as part of User 1's account information on the server. User 1 can also access the message via web browser by logging in to User 1's account on a website operated by the server. The message transmitted by the server indicates that the leveraged wager has increased in value by $25. The server also updates User 1's account to reflect the addition in value (noting by the “*” and other means that the value is related to a pending wager). At this point, User 1 can use the additional value to add to the leveraged wager (if offered by the server), add the value to a new wager (leveraged or traditional) that is offered by the server, or take no action. This is one benefit of the described system, the real time increase in value of a wager when the wagering odds (or other circumstances) dictate a change in value according to the factors used by the server which is constantly evaluating the value. As discussed herein, the server may also decrease the value of a wager selected by a user of the system. In this particular example, User 1 does not elect the use of the additional value at this point in time.

At 607, the wagering line for the Gorillas game (i.e., the server wagering line) changes to Gorillas −9. Upon line change, the server sends a message to User 1. The message transmitted by the server indicates that the pending leveraged wager has increased in value by $50. The server also updates User 1's account to reflect the change in value. User 1 receives the message and elects not to use the additional value at this point in time.

At 608, the Gorillas game begins and the opening kickoff is returned by the Crocodiles for a 7-0 lead (extra point good). At 609, the server sends a message to User 1 that the value of the pending leveraged wager has decreased due to in-game circumstances and that a $50 dollar deposit is required within 15 minutes to avoid liquidation of the of bet. The message is sent by the server via email, text message, and to the application on User 1's smart phone. In this particular example, when setting up the account, User 1 elected to have “liquidation” messages sent to those three means of communication. Embodiments of the invention allow users to input their preferences for such communication as well as other communications from the wagering services server. In various embodiments, the liquidation message can also be viewed via web browser login or through any other means that a user can access the sports wagering services server.

At 610, User 1 selects a deposit of $50 from the smartphone application, which transmits the deposit to the server, where it is verified and credited to the pending wager, which is still worth a maximum of $500 to the user (−110 odds pays $100 on a $110 bet, times 5 equals $500). It is one advantage of the invention that additional deposits (like the one made by User 1) are used by the server to mitigate the risk of leveraged wagers when the value of the wager decreases. The inventive systems and methods may not be able to compensate for all risks to the operator of the server related to pending leveraged wagers, and in certain circumstances the operator will take losses on leveraged wagers (for example, where the amount recouped is less than the amount sought to be won by the user). But the ability to mitigate the possible losses and at the same time allow a user to access leveraged wagering opportunities remains a unique and useful innovation of the described systems and methods. This innovation emerges from the real time analysis of the value of the wager by the server as well as the communication between server and user related to value of the wager.

At 611, the Gorillas have retaken the lead and the score is 28-14. At 612, the server sends a message to User 1 indicating the value of the pending wager has now increased in value $50. In some embodiments of the invention, users (like User 1) can be presented by the server with the additional option of withdrawing the additional value that was added to the wager during the game (either via deposit or by the server). User 1 elects not to use the additional value at this point in time.

At 613, the score remains 28-14 at the end of the third quarter. At 614, the Crocodiles score a touchdown with 5 minutes remaining in game. At step 615, the server sends a message to User 1 indicating the value of the pending wager is back to even, and the $50 of additional value attributed to the pending leveraged wager has been deducted from User 1's account.

At 616, the Crocodiles get possession of the football at the 50 yard line with 1:45 remaining. At 617, the server sends a message to User 1 indicating that the value of the pending wager has changed and a $250 deposit is required within 90 seconds to avoid liquidation of the leveraged wager.

At 618, User 1 selects $250 for deposit via smartphone application. The application then transmits the deposit selection and the server receives and verifies the deposit. The server then credits $250 to the pending leveraged wager (which still pays $500 on top of the wagered amount).

At 619, the Gorillas intercept a pass and gain possession of the football with 25 seconds remaining. At 620, the server sends a message to User 1 indicating the value of the pending leveraged wager has increased and User 1's account has increased by $595. User 1 elects not to use the increased value at this point in time.

At 621, the Gorillas game ends with a final score of 28-21 and the server immediately credits $610 to User 1's account ($110 bet+$500 leveraged winnings) and a message is sent by the server indicating the credit. At this point in time, the $610 is not subject to any pending wager and can be withdrawn from User 1's account to a financial institution as provided by User 1 (or a check from the operator of the sports wagering services server can be requested by User 1 through interaction with the server—the check can be automatically processed by the server upon request and transmission of the request to the server in various embodiments).

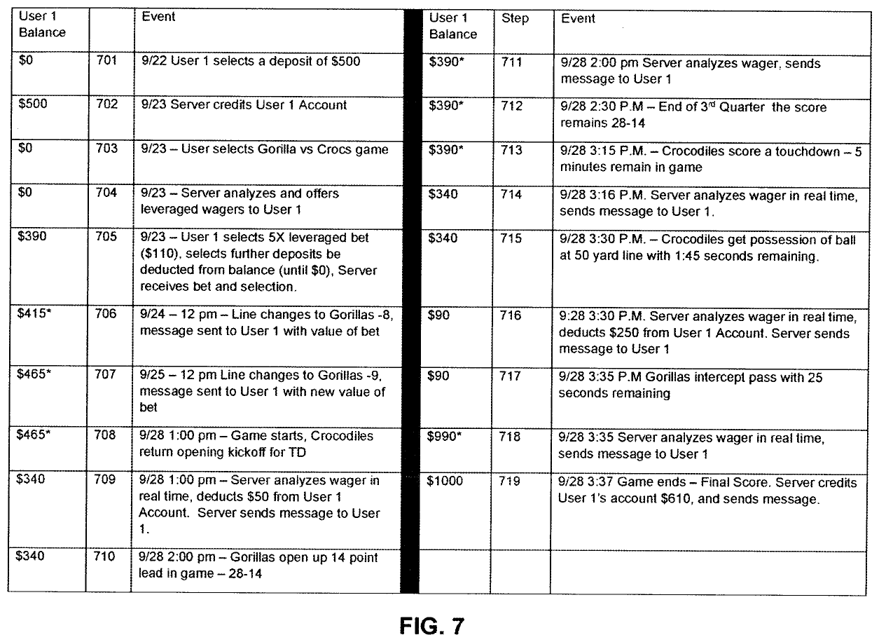

FIG. 7 is a diagram showing another example of an embodiment of the inventive system following the selection of a leveraged bet with the sports wagering system. Particularly, FIG. 7 details an example of events and actions performed by the server that could follow the placement of the 5× $110 wager on the Gorillas (−6.5) versus Crocodiles pro football game previously discussed in FIG. 4. The first column of FIG. 7 shows User 1's account balance (saved and updated in the system server) events take place. As indicated in FIG. 7 and the description of events, in this particular example User 1 selects a leveraged wager with less than the amount of funds in User 1's account (only $110 of the available $500).

At 701, User 1 selects a deposit of $500 from a smartphone application. The application transmits the selection of the deposit to a server (e.g., the wagering services server in FIG. 1). In 702 the server receives User 1's selection of the deposit, verifies the financial information, and credits User 1's account with $500. At 703, User 1 selects the Gorillas vs. Crocodiles game on the smartphone application, the selection is then transmitted by the application and received by a server.

At 704, the server analyzes a plurality of factors, including historical and current sports data, historical and current wagering odds data, and metadata related to User 1 and other users of the sports wagering services provided by the operator of the server. Following the analysis, the server transmits to User 1's smartphone the wagers available at that time by the system for the Gorillas versus Crocodiles game, including leveraged wagers. One of the wagers received and displayed by the application on User s phone is a 5× leveraged wager for a −6.5 spread bet (−110 odds) on the Gorillas.

At 705, User 1 selects the 5× leverage bet for $110 and the application transmits the selection to the server which is received. User 1 further selects that any deposits required for the pending leveraged wager be deducted from User 1's existing balance (either deposited or value from other pending wagers). This selection is also transmitted by the application to the server. In some embodiments of the invention, a user may select to have funds required for pending leveraged wagers be withdrawn from known financial institutions provided by the user (e.g., up to a certain selected amount), or from the existing balance up to a selected amount (as done by User 1 here). This selection of funds for existing leveraged wagers can be performed prior to a wager being selected, or after. Upon receipt of the selection, the server debits User 1's account $110 while the leveraged wager is pending. From this point, until completion of the Gorillas game, the server continuously analyzes the leveraged wager using a plurality of factors discussed herein (e.g., the factors described in FIG. 3). As User 1's account is updated, including with the updated value of User 1's account, the server will provide the updated information to the device that User 1 is using to access the wagering services system, (i.e., smartphone application, personal computer software, web browser).

At 706, the wagering line for the Gorillas game—specifically the line used and offered to users by the server for that game—changes to the Gorillas (−8). Upon line change, the server sends a message to User 1 via the application on User 1's smartphone and also sends the same message to User 1's email which is stored as part of User 1's account information on the server. User 1 can also access the message via web browser by logging in to User's 1 account on a website provided by the server. The message transmitted by the server indicates that the leveraged wager is now valued at $25 more than User 1 selected to wager. The server also updates User 1's account to reflect the addition in value (noting by the “*” and by other means that at least some of the value in the user's account is related to a pending wager). At this point, User 1 can use the additional value to add to the leveraged wager (if offered by the server), add the value to a new wager (leveraged or traditional) that is offered by the server, or take no action. In this particular example, User 1 does not elect the use of the additional value at this point in time.

At 707, the wagering line for the Gorillas game (i.e., the server wagering line) changes to Gorillas −9. Upon line change, the server sends a message to User 1. The message transmitted by the server indicates that the pending leveraged wager has now increased in value by $50. The server also updates User 1's account to reflect the change in value. User 1 receives the message and elects not to use the additional value at this point in time.

At 708, the game begins and the opening kickoff is returned by the Crocodiles for a 7-0 lead (extra point good). At 709, the server sends a message to User 1 indicating that the value of the pending leveraged wager has decreased due to in-game circumstances and that $50 has been deducted from User 1's existing balance in order to avoid liquidation of the bet. In some embodiments, a user may select that no amount should be added from a user's existing balance to avoid liquidation. In further embodiments, a user can require an actual selection by the user to avoid liquidation even if the user's balance is adequate to fund the required deposit amount.

At 710, the Gorillas have retaken the lead and the score is 28-14. At 711, the server sends a message to User 1 indicating the value of the pending wager has increased in value by $50. User 1 elects not to use the additional value at this point in time.

At 712, the score remains 28-14 at the end of the third quarter. At 713, the Crocodiles score a touchdown with 5 minutes remaining in game. At 714, the server sends a message to User 1 indicating the value of the pending wager is back to even, and the $50 of additional value attributed to the pending leveraged wager has been deducted from User 1's account.

At 715, the Crocodiles get possession of the football at the 50-yard line with 1:45 remaining. At 716, the server sends a message to User 1 indicating that the value of the pending wager has changed and $250 has been deducted from User 1's account to avoid liquidation of the bet. The server also credits $250 to the pending leveraged wager (which still pays $500 on top of the existing wagered amount).

At 717, the Gorillas intercept a pass and gain possession of the football with 25 seconds remaining. At 718, the server sends a message to User 1 indicating the value of the pending leveraged wager has increased and User 1's account has increased by $900. User 1 elects not to use the increased value at this point in time.

At 719, the Gorillas game ends with a final score of 28-21 and the server immediately credits $910 to User 1's account ($410 bet+$500 leveraged winnings) and a message is sent by the server indicating the credit. At this point in time, the $910 is not subject to any pending wager and can be withdrawn from User 1's account as described previously herein, or through by any other similar known means.

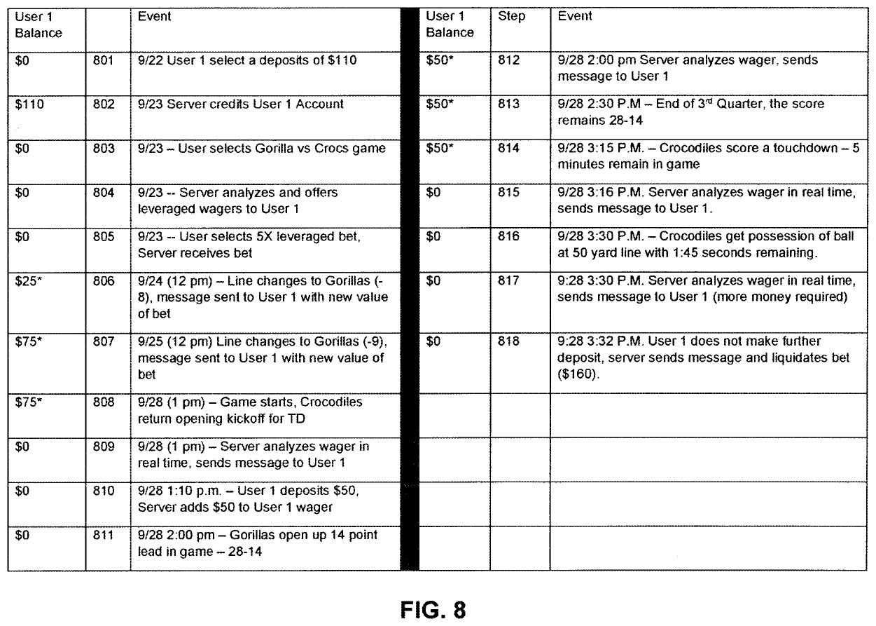

FIG. 8 is a diagram showing another example of an embodiment of the invention following the selection of a leveraged bet with the sports wagering server. Particularly, FIG. 8 details an example of events and actions performed by the system that could potentially follow the placement of the 5× $110 wager on the Gorillas (−6.5) versus Crocodiles football game previously discussed in FIG. 4. The first column of FIG. 8 shows User 1's account balance (saved and updated in the system server) as events take place.

At 801, User 1 selects a deposit of $110 from a smartphone application. The application then transmits the selection of the deposit to a server (e.g., the wagering services server in FIG. 1). At 802, the server receives User 1's selection of the deposit, verifies the financial information, and credits User Us account with $110. At 803, User 1 selects the Gorillas vs. Crocodiles game on an application on his smartphone, the selection is transmitted by the application and received by a server. At 804, the server analyzes a plurality of factors and transmits to User 1's smartphone the wagers available at that time by the system for the Gorillas versus Crocodiles game, including leveraged wagers. One of the wagers received and displayed by the application on User 1's phone is a 5× leveraged wager for a −6.5 spread bet (−110 odds) on the Gorillas.

At 805, User 1 selects the 5× leverage bet for $110 and the application transmits the selection to the server which is received. Upon receipt, the server debits User 1's account $110 while the leveraged wager is pending. From this point, until completion of the Gorillas game, the server continuously analyzes the leveraged wager using a plurality of factors discussed herein. As User 1's account is updated, including with the value of User 1's account (including the pending wagers), the server will provide the updated information to the device that User 1 is using to access the wagering services system, (i.e., smartphone application, personal computer software, web browser).

At 806, the wagering line for the Gorillas game (the line used and offered to users by the server for that game) changes to the Gorillas (−8). Upon line change, the server sends a message to User 1 via the application on User 1's smartphone and also sends the same message to User 1's email. The message transmitted by the server indicates that the leveraged wager has increased in value by $25. The server also updates User 1's account to reflect the addition in value (noting by the “*” and other means that the value is related to a pending wager). At this point, User 1 can use the additional value to add to the leveraged wager, add the value to a new wager (leveraged or traditional) that is offered by the server, or take no action. In this particular example, User 1 does not elect the use of the additional value at this point in time.

At 807, the wagering line for the Gorillas game changes to Gorillas (−9). Upon line change, the server sends a message to User 1. The message transmitted by the server indicates that the pending leveraged wager has increased in value by $50. The server also updates User 1's account to reflect the change in value. User 1 receives the message and elects not to use the additional value at this point in time.

At 808, the Gorillas game begins and the opening kickoff is returned by the Crocodiles for a 7-0 lead (extra point good). At 809, the server sends a message to User 1 that the value of the pending leveraged wager has decreased due to in-game circumstances and that a $50 dollar deposit is required within 15 minutes to avoid liquidation of the of bet. The message is sent by the server via email, text message, and to the application on User 1's smart phone.

At 810, User 1 selects a deposit of $50 from the smartphone application, which transmits the deposit to the server, where it is verified and credited to the pending wager, which still pays a maximum of $500 to the user (on top of the deposited amount).

At 811, the Gorillas have retaken the lead and the score is 28-14. At 812, the server sends a message to User 1 indicating the value of the pending wager has increased in value by $50. User 1 elects not to use the additional value at this point in time.

At step 813, the score remains 28-14 at the end of the third quarter. At 814, the Crocodiles score a touchdown with 5 minutes remaining in game. At 815, the server sends a message to User 1 indicating the value of the pending wager is back to even, and the $50 of additional value attributed to the pending leveraged wager has been deducted from User 1's account.

At 816, the Crocodiles get possession of the football at the 50 yard line with 1:45 remaining. At 817, the server sends a message to User 1 indicating that the value of the pending wager has changed and a $250 deposit is required within 90 seconds to avoid liquidation of the leveraged wager.

At 818, the server liquidates the bet and User 1's $160 wager is lost to the operator of the server. The server may hold pending wager amounts in the same or different accounts then the final amounts credited to the sports wagering services operator. User 1's account has a value of zero at this point. The server sends a message to User 1 indicating the leveraged wager has been liquidated and User 1's account is no longer funded.

One of the unique aspects of the invention is the server's ability to continuously analyze wagers in real time (like the example described in FIG. 8), and to mitigate the risk associated with leveraged wagers. As previously discussed, not all risk can be alleviated by the server's real time analysis, but the ability of the system to mitigate some risk while at the same time allowing users of the system to use increased leverage in their wagering is an advancement.

In certain embodiments of the invention, the system and methods further comprise the selection of “parlay” wagers by a user—i.e. the selection of multiple games in one wager. In certain embodiments of the system, leveraged wagers are offered by the wagering services server for parlay wagers that are selected by a user. The offering, selection, and execution can be similar, if not the same, as the examples described in FIGS. 4, 6, 7, and 8.

Further, similar to the embodiments discussed herein, a server providing the wagering services can continuously analyze a parlay wager selected by a user (and received by a server) until each sporting event associated with the parlay wager is completed or resolved (i.e., a cancellation of the event or the like). Further, in some embodiments, a user may sell the parlay bet at any point in time prior to the bets completion for the price offered by the server (e.g. the value of the wager) or in certain embodiments the price offered by another user of the system or third party.

For example, in one embodiment a user selects five sporting events for a parlay wager (each having −110 odds) from an application on the user's smart phone device. The odds offered by the server and displayed in the application for such a wager are 20:1 (at the time of the wager). The application then transmits the selection of the games (and parlay wager) to the server. Thereafter, the server continuously analyzes the value of the parlay wager until the completion of the sporting events comprising the parlay. In particular embodiments, the server sends a message to the user at least at the end of each sporting event in the parlay that includes the value of the parlay wager at that point in time. The user may also view the current value of the wager by accessing the user's account via smart phone application, web browser, downloaded software, or similar means. By providing real time analysis of wager in this manner, the systems and methods of the invention offer a user the ability to minimize the risk of a parlay and to be able to cash out (at some value) prior to the end of all events (if none of the selected events has been unfavorable to that point).

In certain embodiments, the real time analysis of a wager by a wagering services server using a plurality of factors (and offering current sale value of standard bets and/or leveraged bets) can be applied to “teaser” type wagers (i.e., where a certain amount of points are spread over multiple sporting event wagers), For example, if a user has selected a two game, 6 point teaser, the server would analyze the bet until the completion of both games. In various embodiments, the server would send a message to the user after the first game in the teaser was completed that included a current value of the teaser bet. In certain embodiments, leveraged wagering as described in this application can also be offered by a wagering services server for a teaser type bet.

In certain embodiments of the inventive system and method, a wagering services server (e.g., server 101 in FIG. 1) can offer and analyze any type of sports wager (leveraged or traditional) in real time and assign a value to the wager. The analysis by the server can be based on a plurality of factors which can include stored historical sports and wagering odds data, a live sports data stream and a live sports wagering data, and metadata from the users of the system. In certain embodiments, the assigned value of a pending wager (leveraged or traditional) can be sold by the user at any time by selecting the assigned sale price in an application (or other similar means), the selection is then transmitted to the server where it is received and the value of the wager is credited to the user's account and the pending wager is removed from the user's account.

In a further embodiment, a wagering services server can provide competitive sports futures bets for wagering by a user. A unique aspect of the systems and methods is that futures bets are analyzed by the server in real time until the time of completion of the related future event and assigned a value at all times. As such, the user can sell the bet for a certain value at any point until the time of completion, in certain embodiments, other users of the system can also purchase futures bets offered through the wagering services server that have been offered and/or sold by other users of the wagering services system.

In an example of an embodiment of the invention, the server offers a futures wager of 100-1 that the Gorillas will win the Championship of the Hypothetical Football League, Prior to the beginning of the football season, a user selects the Gorillas 100-1 wager offered by the wagering services server for an amount of $10 through an application on the user's smart phone. After placing the wager, the Gorillas complete a trade for Abe Simian, the current five time MVP. The server, which is continuously analyzing the placed 100-1 Gorillas future bet, assigns a value of $150 to the original $10 wager. Some of the data considered in the factors used by the server for continuously analyzing a futures bet can be stored historical sports and wagering odds data, a sports data stream and sports wagering data stream, and metadata from the users of the system.

In certain embodiments, third parties (other than the operator of the system) can have access to the futures bets—and other wagers—placed by users of the system and can make offers for purchasing the placed wagers. The wagering services server can store and use the data from these offers in analyzing and assigning valuations to futures wagers and/or other wagers. In certain embodiments, the offers placed by third parties with access to wagers placed in the system can be accepted by the users of the system. In certain embodiments, the server determines the value of the placed futures wager after an offer from a third party, and the server buys the wager if the user chooses to sell. Thereafter, the server may sell the wager to a third party or users of the system for a price determined by the server.

In a particular embodiment, a third party can access the futures wagers and/or other wagers selected by users and received by the system for a cost determined by the operator. In certain embodiments, the third party user of the system cannot see the personal information and/or financial information of the users of the system but may have access to anonymized metadata related to historical and/or current wagering data of users of the system. As discussed herein, a “third party” is not a typical user of the system but instead has access to at least one item of information not accessible to a standard user. For example, the third party may have access to at least the data related to specific futures wagers that have been placed on this system by a standard user.

In certain embodiments of the system, a leveraged betting option can be offered for futures betting. For example, similar to FIGS. 4, 6, 7, and 8, a 100-1 Gorillas future bet may be offered at lox leverage to a user by the server. This type of leveraged futures bet may be subject to the same changes as leveraged bets discussed herein. For example, if the odds of the future go up or down, value may be gained or lost in the users account. Further, deposits may be required to avoid liquidation in certain circumstances. In certain embodiments, the value gained in a futures wager (and other wagers) may be added to the leveraged wager to add further leverage (i.e. 2× to 3× and so forth).

In certain embodiments of the system, the server may communicate offers to users of the system to buy certain pending futures bets (or other sports bets—leveraged and traditional) at particular prices for particular amounts of the wager being sold. For example, the server may transmit an offer to users of the system (via an application, website, or the like) of $1.25 for every dollar of pending wager on the Gorillas 100-1 to win the championship (minimum of $100 dollars pending wager to be sold). Similarly, the server may communicate to users of the system offers to sell a pending wager of the Gorillas 100-1 for $1.30 (for each dollar originally wagered) pith a minimum of $200 to be purchased. In various embodiments, the amounts offered by the server to buy and sell certain pending wagers are communicated on a website, smart phone application, or the like, that can be accessed by the public. In various embodiments, offers to buy and sell certain pending wagers by the server are communicated to all users of the system. In various embodiments of the system, offers to buy and sell certain pending wagers by the server are only communicated to third parties, In various embodiments of the system, users of the system may sell pending leveraged wagers to the server (and/or third parties) including the entire leveraged amount of the pending wager (e.g. $5000-$1000 5× leveraged bet)

In certain embodiments of the system, a user and/or third party may communicate offers to buy or sell certain pending wagers to the server. In various embodiments, the server may charge a listing fee to a user or third party for such offers to buy or sell certain pending wagers. In various embodiments, the server may charge a transaction fee to the buyer and/or seller of offered pending wagers that are communicated to the server by a user or third party that are purchased/sold by another user or third party. In various embodiments, user/third party offers to buy or sell certain pending wagers communicated to the server are communicated to the public via application, website, or other similar means. In various embodiments, user/third party offers to buy or sell certain pending wagers communicated to the server are not communicated to the public. In certain embodiments, user/third party offers to buy or sell certain pending wagers communicated to the server are communicated to third parties for a fee or on certain terms such as prior amounts of pending wagers attributed to a third party.

What is claimed is:

1. A system for providing wagering services comprising:
at least one server adapted to:
transmit at least one leveraged wagering option related to an event to a user over a network,
receive a selection of a leveraged wagering option from the user over the network,
continuously analyze the selected leveraged wager from the user using a plurality of factors until the event associated with the leveraged wager ends or the leveraged wager is otherwise ended, and
transmit a value of the leveraged wager to the user over the network based on the continuous analysis.

2. (canceled)

3. (canceled)

4. The system of claim 1 wherein the selected wager received by the server is a leveraged wager for a single bet on a single sporting event.

5. The system of claim 1 wherein the server is adapted to send a request for an additional deposit from the user when the value of the wager decreases.

6. The system of claim 5 wherein the server is adapted to liquidate the leveraged wager based on the analysis of the server and the failure of the server to receive the additional deposit from the user.

7. The system of claim 1 wherein the server is adapted to receive the selection from the user to sell the selected wager.

8. (canceled)

9. The system of claim 1 wherein the event is not a sporting event.

10. A method for providing wagering services using a data processing system, said data processing system performs the operations comprising:
transmitting at least one leveraged wagering option related to an event to a user over a network,
receiving the selection of a leveraged wagering option from the user
continuously analyzing the selected leveraged wager from the user using a plurality of factors until the event associated with the leveraged wager ends or the wager is otherwise ended, and
transmitting a value of the leveraged wager to the user over the network based on the continuous analysis.

11. (canceled)

12. (canceled)

13. The method of claim 10 wherein the selected leveraged wager received by the data processing system is a leveraged wager for a single bet on a single sporting event.

14. The method of claim 10 wherein the data processing system further performs the operation of sending a request for an additional deposit from the user when the value of the leveraged wager decreases.

15. The method of claim 14 wherein the data processing system further performs the operation of liquidating the leveraged wager based on the analysis of the server and the failure of the data processing system to receive an additional deposit from the user.

16. The method of claim 10 wherein the data processing system further performs the operation of receiving a selection from the user to sell the selected wager.

17. The method of claim 10 wherein one at least one leveraged wagering option is a futures wager.

18. The method of claim 10 wherein the event is not a sporting event

19. A system for providing wagering services comprising:
a data processing system adapted to:
transmit at least one leveraged wagering option related to an event to a user over a network;
receive the selection of a leveraged wagering option from the user over the network;
continuously analyze the selected leveraged wager from the user using a plurality of factors until the event associated with the wager ends or the wager is otherwise ended; and,
transmit a value of the leveraged wager to the user over the network based on the continuous analysis upon an increase or decrease in the value of the wager.

20. The system for providing wagering services of claim 19 wherein the data processing system comprises at least one server.

21. The system of claim 1 wherein the server is adapted to liquidate the leveraged wager when the value of the wager reaches a preset limit.

22. The system of claim 1 wherein the selected wager received by the server is a leveraged wager on a futures bet.

23. The method of claim 10 wherein the data processing system further performs the operation of liquidating the leveraged wager when the value of the wager reaches a preset limit.
